(19) United States
(12) Patent Application Publication
(10) Pub. No.: US 2015/0292603 A1
(43) Pub. Date: Oct. 15, 2015

(54) PULLEY DEVICE FOR BELT OR CHAIN, MANUFACTURING PROCESS OF AN HOLLOW SHAFT FOR SUCH A DEVICE AND ASSEMBLY PROCESS OF SUCH A DEVICE

(71) Applicants: Laurent CHERIOUX, Tours (FR); Mikael LASSERRE, Saint-Pierre-des-Corps (FR); Alain LLOZE, Amaye sur orne (FR); Pascal MAUROY, Saint-Cyr-sur-Loire (FR); Thierry PROUTEAU, Tours (FR)

(72) Inventors: Laurent CHERIOUX, Tours (FR); Mikael LASSERRE, Saint-Pierre-des-Corps (FR); Alain LLOZE, Amaye sur orne (FR); Pascal MAUROY, Saint-Cyr-sur-Loire (FR); Thierry PROUTEAU, Tours (FR)

(73) Assignee: AKTIEBOLAGET SKF, Goteborg (SE)

(21) Appl. No.: 14/681,180

(22) Filed: Apr. 8, 2015

(30) Foreign Application Priority Data
Apr. 11, 2014 (FR) 1453281

(51) Int. Cl. F16H 7/20; F16C 33/78; F16H 55/36

(52) U.S. Cl. CPC F16H 7/20; F16H 55/36; F16C 33/7886

(57) ABSTRACT

A pulley device for a belt or chain, the pulley device comprising a bearing provided with an external ring, an internal ring, and at least one row of rolling elements mounted in a bearing chamber defined between the external and internal rings. A pulley is secured in rotation with the external ring and provided with an external radial surface for engaging with a belt or chain. Also included is at least one hollow shaft able to receive a screw for mounting the pulley device on a support. The hollow shaft forming a structural unit comprising a bushing, a flange secured to the bushing, and which extends, from the bushing, radially outwards, respective to a central axis of the hollow shaft, as far as the bearing chamber. The flange is formed with a washer and an endplate, while the washer is radially located between the bushing and the endplate.

### CROSS REFERENCE TO RELATED APPLICATIONS

This is a Non-Provisional Patent Application, filed under the Paris Convention, claims the benefit of France Patent (FR) Application Number 1453281 filed on 11 Apr. 2014 (11.04.2014), which is incorporated herein by reference in its entirety.

### FIELD OF THE INVENTION

The invention relates to a pulley device as used, in particular in automobile vehicles. Such a device may relate to tensioning rollers for tensioning a chain or a movement transmission belt, accessory rollers, winders, idler pulleys and any other means for supporting or returning a rotary movement.

### PRIOR ART

As this emerges from FR-A-2 923 281, a pulley device is provided in order to be mounted on a support, such as an engine block of an automobile vehicle, by means of a screw which crosses a hollow shaft positioned at the center of this device. In the embodiment of FIG. 7 of FR-A-2 923 281, the hollow shaft is formed with a bushing equipped with a spacer which will bear against an inner ring of a bearing, which avoids plastic deformation of the bushing under the effect of an axial force exerted by the screw. Globally this gives satisfaction.

This equipment of the prior art includes a bearing chamber in which are positioned balls and which has to be protected against external contaminations by means of two sets of joints mounted on one of the rings of the bearing and which will frictionally bear against the other ring. These sets of joints are relatively expensive and require a specific mounting step, during the manufacturing of the known pulley device. This in-proportion increases the price cost of this equipment.

These are the drawbacks which the invention more particularly intends to remedy by proposing a novel pulley device for a belt or a chain which is faster and more economical to make than those of the state of the art, while having good properties for protecting its bearing chamber against external contaminations.

### OBJECT AND BRIEF SUMMARY OF THE INVENTION

For this purpose, the invention relates to a pulley device for a belt or chain comprising:

a bearing provided with an external ring, an internal ring and at least a row of rolling elements mounted in a bearing chamber defined between the external and internal rings,

a pulley secured in rotation with the external ring and provided with an external radial surface for engaging with a belt or a chain and

at least one hollow shaft able to receive a screw for mounting the pulley device on a support.

The hollow shaft of the pulley device forms a structural unit which comprises a bushing and a flange secured to this bushing and which extends radially, from the latter, outwards with respect to a central axis of the hollow shaft, as far as the bearing chamber. According to the invention, the flange is formed with a washer and an endplate and the washer is located radially between the bushing and the endplate.

By means of the invention, the flange, which belongs to the structure of the hollow shaft, ensures a barrier function between the bearing chamber and the outer environment of the device, which protects this bearing chamber from external contaminations. It is thus possible to do without usual sealing means, such as lip gaskets mounted on rigid structures, between the internal and external rings.

According to advantageous but not mandatory aspects of the invention, such a device may incorporate one or more of the following features, taken in any technically acceptable combination:

An external radial edge of the flange forms a joint which cooperates with the external ring and/or the pulley for isolating the bearing chamber from the outside of the device.

The washer is made in a more rigid material than the material of the endplate and positioned so as to receive with axial support a head of a mounting screw of the device on a support and/or a raised/recessed portion of the support.

The bushing is made in a synthetic material.

The endplate is made in a synthetic material.

The bushing and the endplate are made in a same material.

The washer is metallic.

The synthetic material may be polyamide 6-6.

The material comprises reinforcement fibers, for example glass fibers.

The washer is provided with raised/recessed portions cooperating with mating raised/recessed portions of the bushing and/or of the endplate and participating in relative immobilization of these parts.

The axial thickness of the washer is less than its radial width relatively to a central axis of the hollow shaft.

A ratio of the axial thickness of the washer over its axial width is comprised between 0.1 and 0.5, preferably equal to 0.3.

The device comprises two identical hollow shafts each forming a structural unit comprising a bushing and a flange, while the bushings are aligned along a central axis of the bearing and the flanges are each positioned on one side of the bearing chamber, along the central axis of the bearing.

The bushing comprises raised/recessed portions, such as ribs, so as to cooperate with a bore of the internal ring, said bushing being preferentially forcibly mounted in said internal ring.

Further, the invention relates to a method for manufacturing a hollow shaft belonging to a device as mentioned above. According to the invention, this method comprises at least one step of overmolding the bushing and/or the endplate on the washer.

Preferentially, the bushing and the endplate are made in a same material and over molded at the same time on the flange.

Finally, the invention relates to a method for assembling a pulley device of the type mentioned above, this method comprising preliminary steps for mounting the bearing and the pulley with the external ring. According to the invention, this method comprises a step subsequent to the preliminary steps and consisting in engaging inside the internal ring of the bearing, a bushing belonging to a structural unit forming a hollow shaft, by bringing it facing the bearing chamber, along an axial direction, an endplate belonging to the flange secured to the bushing and belonging to the structural unit, while this endplate forms, with a washer located radially between the endplate and the bushing, the flange.

Alternatively, provision may be made for proceeding with overmolding of the bushing in the internal ring. In this case, the invention also relates to a method as mentioned above, this method being characterized in that it comprises steps consisting in overmolding inside the internal ring of the bearing a bushing belonging to a structural unit forming a hollow shaft and attaching by overmolding, adhesive bonding, tightened mounting, crimping or vulcanization, an endplate on a washer in order to form a flange of the hollow shaft.

### BRIEF DESCRIPTION OF THE DRAWINGS

The invention will be better understood and other advantages thereof will become more clearly apparent in the light of the description which follows, of an embodiment of a pulley device, of a manufacturing method and of an assembling method according to its principle, only given as an example and made with reference to the appended drawings wherein:

FIG. 1 is a partly exploded axial sectional view of a pulley device according to the invention;

FIG. 2 is a perspective view of a hollow half-shaft belonging to the pulley device of FIG. 1;

FIG. 3 is a perspective view of the half-shaft of FIG. 2 along another angle; and

FIG. 4 is an axial sectional view of the device of FIG. 1 in a configuration of use.

### DETAILED DESCRIPTION OF PARTICULAR EMBODIMENTS

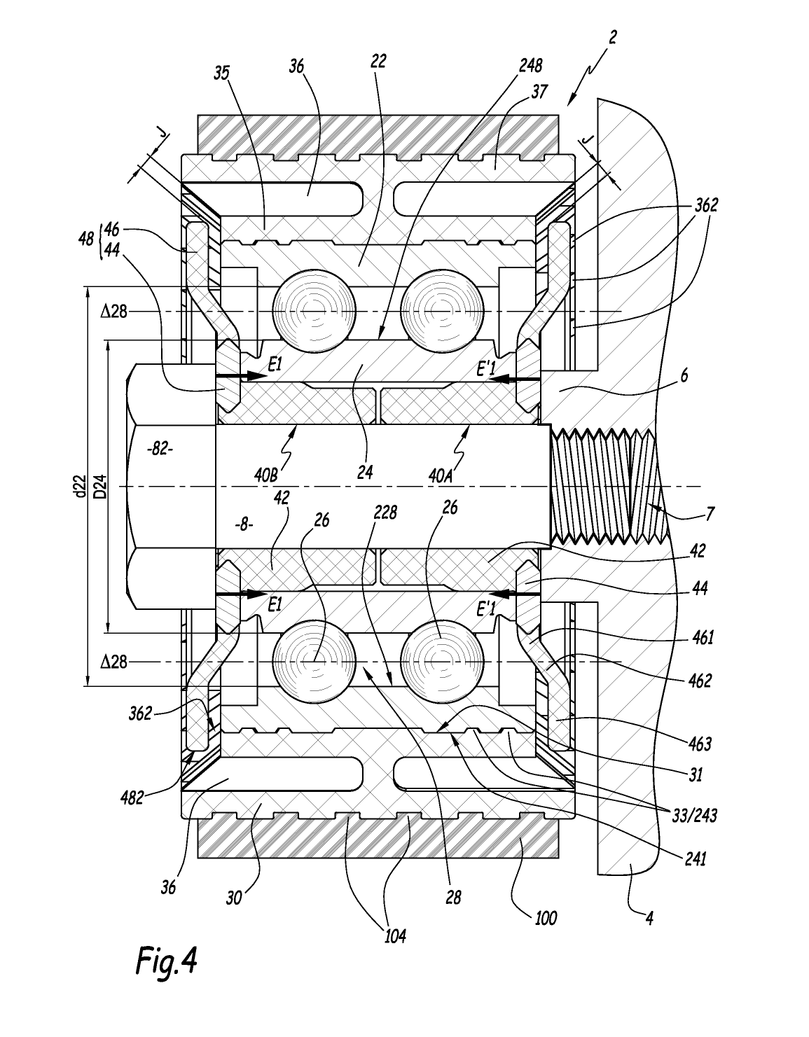

The pulley device 2 illustrated in the figures forms an idler pulley intended to be mounted on an engine block 4 partly illustrated in FIG. 4 and which is equipped with a boss 6 at the centre of which is made a trapping 7 for receiving a screw 8 engaged at the centre of the device 2.

The pulley device 2 comprises a ball-bearing 20 which is formed with an external ring 22, with an internal ring 24 and two rows of balls 26 positioned in a bearing chamber 28 radially defined between the rings 22 and 24. Alternatively, the bearing 20 may comprise a cage for maintaining the balls 26 in position. According to another alternative, a single row of balls is provided. Further, rolling bodies other than balls may be used in the bearing 20, notably rollers or needles.

The bearing chamber 28 is radially defined between an internal radial surface 228 of the ring 22 and an external radial surface 248 of the ring 24, in which are made tracks as torus sections for partly receiving the balls 26. The diameter of the surface 228 is noted as d22, which is an internal diameter of the ring 22, and the diameter of the surface 248 as D24 which is an external diameter of the ring 24.

A central and longitudinal axis of the pulley device 2 is noted as X2, which is an axis of rotation of the rings 22 and 24 relatively to each other. In the present description, the terms of “axial” or “radial”, are defined with respect to this axis, unless mentioned otherwise. Thus, a direction is “axial” if it is parallel to the axis X2 and radial if it is perpendicular to and secant with this axis. A surface is axial if it is perpendicular to the axis X2 and radial if it is perpendicular to a radial axis relatively to the axis X2.

A pulley 30 is immobilized on the external ring 22, for example by adhesive bonding or overmolding. In the example of the figures, the pulley 30 is made in a synthetic material and its internal radial surface 31 is provided with peripheral ribs 33 engaged into peripheral grooves 243 made on the external radial surface 241 of the ring 22. Alternatively, the pulley 30 may be metal and mounted clamped or crimped on the external ring 22. The external radial surface of the pulley 30 is noted as 32, i.e. the surface of this pulley radially oriented outwards with respect to the axis X2. This surface 32 is provided with peripheral grooves 34.

In a configuration of use, and as illustrated in FIG. 4, a belt 100 in synthetic material is mounted around the device 2 and the internal peripheral ribs 104 of this belt are engaged into the grooves 34, which contributes to guiding the belt 100 around the pulley 30. The surface 32 is therefore a surface for engagement with the belt 100.

Alternatively, a chain may be used in the place of the belt 100. In this case, the geometry of the surface 32 is adapted.

Two half-shafts 40A and 40B are positioned in the internal radial volume V24 of the ring 24 by each being engaged into this volume through one side of the bearing 20. The half-shafts 40A and 40B are identical and in the following, only the half-shaft 40A is described in detail.

This half-shaft 40A comprises a bushing 42 with a circular section and centered on an axis X40 coinciding with the axis X2 in the mounted configuration of the half-shaft 40A in the device 2. The half-shaft 40A also comprises a washer 44 and an endplate 46 which together define a flange 48, which radially extends outwards, from the bushing 42, relatively to the axis X40 and to the axis X2 when the half-shaft 40A is mounted in the device 2.

The external diameter of the flange 48 is noted as D48, i.e. the external diameter of the endplate 46. This diameter is defined by the external radial edge 482 of the flange 48 which is circular.

The washer 44 is located radially relative to the axis X40, between the bushing 42 which is the internal or central radial portion of the half-shaft 40A and the endplate 46 which forms the external radial portion thereof.

In practice, the washer 44 is metal, for example made in steel, while the parts 42 and 46 are made in a synthetic material, notably in polyamide 6-6 or in another synthetic material reinforced with fibers, such as glass or carbon fibers. The manufacturing of the half-shaft 40A may take place by overmolding of the parts 42 and 46 on the washer 44.

In order to guarantee efficient anchoring of the portions 42 and 46 on the washer 44 and according to an optional but advantageous aspect of the invention, mating raised/recessed portions are provided on these parts. More specifically, and as visible in FIG. 3, the washer 44 is equipped with four tabs 442 which extend radially relatively to the axis X40 and towards the latter, from its internal radial edge 441 and into which engages the edge 421 of the bushing 42 turned towards the washer 44. The edge 421 is provided with notches 422 with a shape mating that of the tabs 442, which ensures efficient hooking-up between the parts 42 and 44.

In the same way, tabs 446 extend radially to the axis X40 and outwards, with respect to the external radial edge 445 of the washer 44. They are received in notches 466 made on the internal radial edge 465 of the endplate 46. This contributes to firm immobilization between the parts 44 and 46.

Alternatively, other raised/recessed attachment portions may be provided between the parts 42, 44 and 46. In particular, the tabs 442 and 446 may be replaced with notches into which engage tabs respectively formed on the parts 42 and 46.

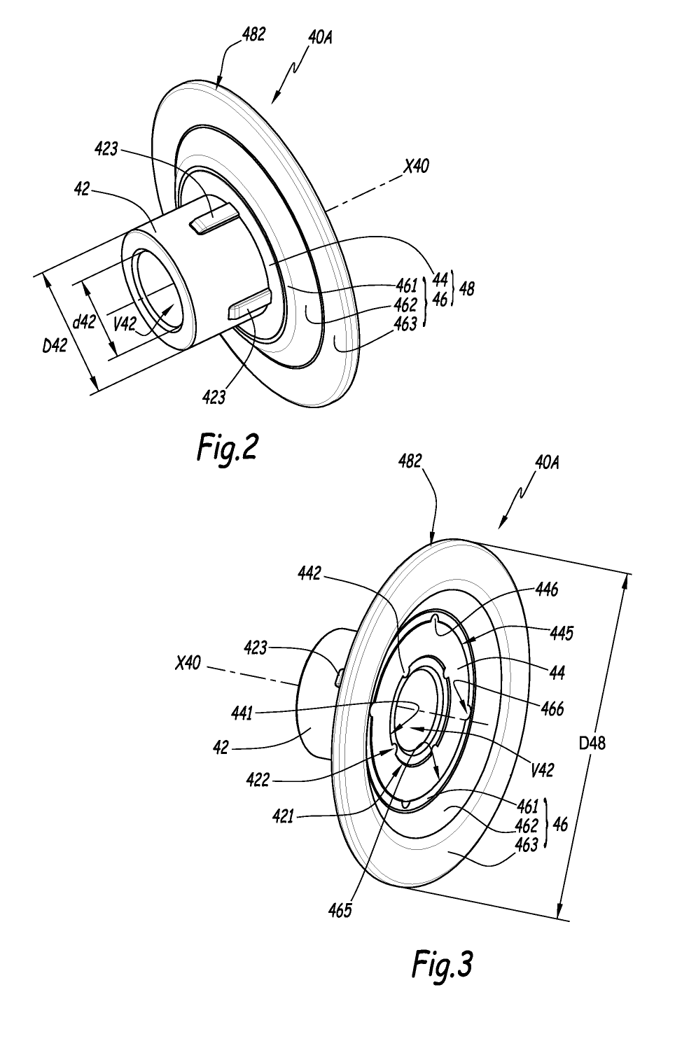

As this more particularly emerges from FIG. 2, the bushing 42 is equipped with four external axial ribs 423 which form over-thicknesses localized relatively to the bushing 42. The ribs 423 are regularly distributed around the axis X40.

The outer diameter of the bushing 42 measured at a distance from the ribs 423 is noted as D42. The diameter of an envelope surface tangent with the external radial surfaces of the ribs 423 is noted as D42′. The diameter D42′ is strictly greater than the diameter 42, the difference between both of these diameters being equal to double the radial thickness, relatively to the axis X40, of the ribs 423.

The inner diameter of the internal ring 24 is noted as d24. The diameter D42 is strictly less than the diameter d24, which allows a portion of the bushing 42 opposite to the washer 44 to be introduced with play into the internal volume V24 of the ring 24.

The diameter D42′ is equal to or slightly greater than the diameter d24, which allows introduction of the bushing 42 into the inside of the volume V24 with the ribs 423 being firmly pressed against the internal radial surface of the ring 24, possibly in return for deformation of the bushing 42. Thus, the bushing 42 is forcibly mounted in the ring 24. This contributes to firm immobilization of the bushing 42 in the volume V24. This is particularly useful when both the half-shafts 40A and 40B are mounted on the bearing 20, before the pulley device 2 is itself mounted on a support such as the engine block 4 by means of the screw 8. Thus, the ribs 423 ensure a function for not losing the half-shafts 40A and 40B with respect to the remainder of the device 2.

The internal volume of a bushing 42 is noted as V42 and its inner diameter as d42.

During the assembling of the pulley device 2, the bearing 20 is pre-mounted during preliminary steps known per se, by assembling the elements 22, 24 and 26. The pulley 30 is then added onto the ring 22, according to one of the techniques contemplated above.

Next, each of the half-shafts 40A and 40B is engaged into the volume V24 by aligning the bushings 42 on the axis X2, as illustrated by the arrow Fl for the half-shaft 40A, which has the effect of bringing the endplates 46 facing the bearing chamber 28, along a direction 428 parallel to the axis X2 and passing through the centre of a ball 26. In other words, the flange 48, the endplate 46 of which forms the external radial portion extends radially, outwards relatively to the axes X2 and X40 and from the bushing 42, as far as the bearing chamber 28 which it isolates from the outside, to the point that it is unnecessary to mount joints between the rings 22 and 24.

Alternatively, the bushing 42 of each half-shaft 40A or 40B may be over molded in the central bore of the ring 24 formed by the volume V24.

In the sense of the present application, the fact that the flange 48 extends radially as far as the bearing chamber 28 corresponds to the fact that the diameter D48 is strictly greater than the diameter D24. In fact, the diameter D48 is greater than the average of the diameters d22 and D24. In practice, the diameter D48 is even greater than the diameter d22, as this emerges from the figures.

In a mounted configuration of the half-shafts 40A and 40B, their flanges 48 are located on either side of the chamber 28, along the axis X2.

The endplate 46 is not planar and comprises an internal annular, planar and radial portion 461 for attachment on the washer 44, a divergent frusto-conical portion 462 opposite to the bushing 42 moving away from the axis X40 and a planar and annular portion 463 which is perpendicular to the axis X40 and which defines the external radial edge 482 of the flange 48. The non-planar structure of the endplate 46 allows it to be adapted to the geometry of the rings 22 and 24 which do not have the same axial length.

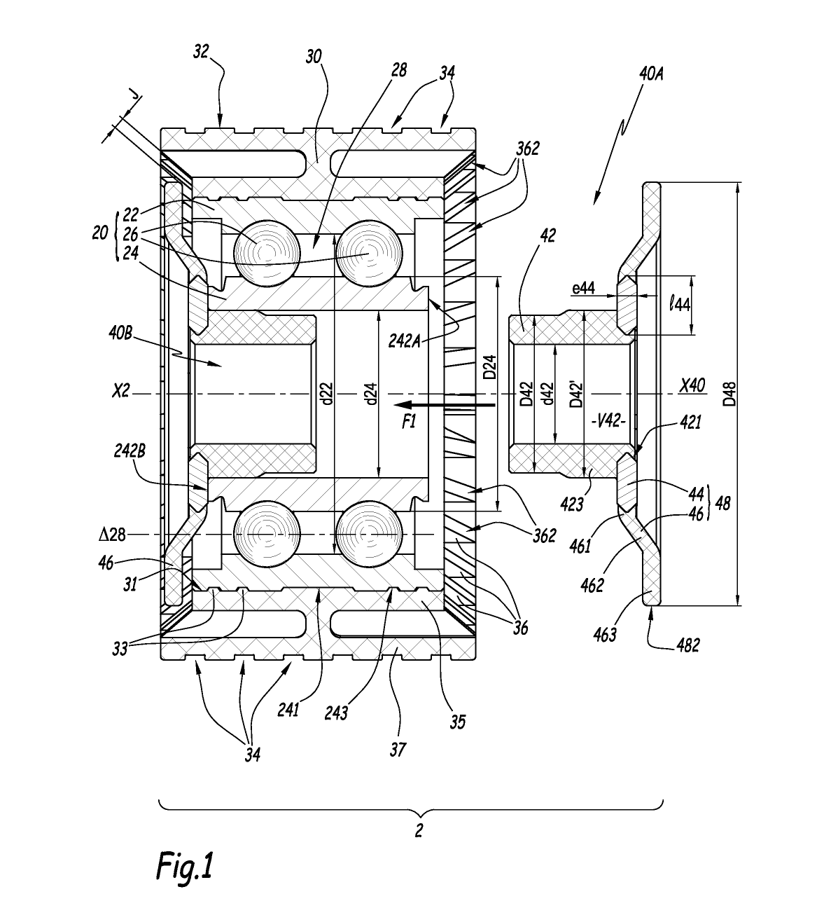

In a mounted configuration of a half-shaft in the device 2, as illustrated on the left of FIG. 1 or in FIG. 4, the washer 44 bears against an axial surface 242A or 242B of the ring 24, while the portion 463 of the endplate 46 is not in contact with the ring 22, nor with the pulley 30. This is consistent with the fact that in the configuration of use, the internal ring 24 does not rotate around the axis X2, not more than the half-shafts 40A and 40B, while the pulley 30 and the outer ring 24 rotate around this axis.

The pulley 30 is equipped with ribs 36 which extend between two webs 35 and 37 respectively defining the internal 31 and external 32 radial surfaces of the pulley 30. The ribs 36 rigidify the pulley 30 while being more lightweight than a solid mass. In a mounted configuration of a half-shaft 40A and 40B within the device 2, the edge 482 of the flange 48 extends in proximity to free tilted edges 362 of the ribs 36, by defining with the latter a play J of the order of a few tenths of millimeters. Thus, the edges 362 and 482 form together a joint with a labyrinth between each half-shaft 40A and 40B and the pulley 30, which contributes to isolating the chamber 28 from the outside and to avoid its contamination.

According to an alternative not shown of the invention, and in return for adaptation of the pulley 30, a lip may be provided on the external radial edge 482 of the flange 48 and may bear against an adapted surface of the pulley 30, in order to form a lip joint.

Alternatively, the play J may be defined between the edge 482 and a lateral surface of the ring 22.

Whether this is the case of a labyrinth joint or in the case of a lip joint, the protective function of the chamber 28 towards external contaminations is ensured by the flange 48 and results from simple mounting of the half-shaft 40A or 40B, in the direction of the arrow F1 in FIG. 1, within the pulley device 2.

In the configuration of FIG. 4, the head 82 of the screw 8 bears against the washer 44 of the half-shaft 40B, while the boss 6 bears against the washer 44 of the half-shaft 40A. Thus, the tightening of the screw 8 in the tapping 7 results in an axial thrust force E1 of the washer 44, the closest to the head 82, against the internal ring 24. This axial thrust force induces, from the boss 6, a reaction force E′1 which pushes the washer 44 the closest to the engine block 4 towards the ring 24. In other words, the ring 24 is pinched by the axial forces E1 and E′1 which are exerted by metal parts, i.e. on one side the head 82 and the washer 44 and on the other side the boss 6 and the washer 44.

The axial thickness of the washer 44 is noted as e44, measured parallel to the axis X40 and its radial thickness radially measured with respect to this axis, is noted as 144. The value of the axial thickness e44 is less than the value of the radial width 144. In practice, the ratio e44/144 is comprised between 0.1 and 0.5, and preferentially equal to 0.3. Thus, the washer 44 is adapted for ensuring a function for transmitting axial forces E1 and E′1 on the one hand and allowing relative position of the parts 42 and 46 on either side of the washer 44 on the other hand. The washer 44 forms a spacer both axially, since it allows transmission of an axial force E1 or E′1, and radially since it centers the parts 42 and 46 relatively to each other.

It is noted that the washers 44 are in contact with the internal ring 24, which ensures axial maintaining of the device 2 along the axis X2, relatively to the engine block 4.

All the constitutive elements of the bearing 20 and the pulley 30 may be mounted conventionally during preliminary steps for manufacturing the device 2. It is then possible to set into place the half-shafts 40A and 40B by taking into account the dimensions of the rod 8 on the one hand and the interface provided on the engine block 4, notably the presence and the dimensions of the boss 6 on the other hand. Thus, the assembling of the device 2 may be finalized when its conditions of use are determined. It is thus possible to prefabricate a large number of sub-assemblies, each comprising a bearing 20 and a pulley 30, and then to end the manufacturing of the pulley devices 2 based on these pre-assembled assemblies, by mounting one or several hollow shafts selected according to the means for mounting the device 2 on the engine block 4. For example, the inner diameter d42 of the bushings 42 may be adapted to the diameter of the screw 8 and the thickness e44 of the washers may be adapted to the length of the screw 8 and of the boss 6. In other words, each hollow shaft 40A and 40B is selected according to means for mounting the device 2 on the engine block 4, which comprise the screw 8 and the boss 6.

The invention is not limited to the illustrated embodiment. Alternatives may be contemplated.

The bushing 42 may be made in metal. Also, the washer 44 may be made in a synthetic material, notably in plastic material, possibly reinforced with fibers.

The pulley 30 may form the external ring of the bearing. In other words, the elements 22 and 30 illustrated in the figures may be formed by a single part.

The bushing of the hollow shaft may form the internal ring of the bearing. In other words, the elements 24 and 42 illustrated in the figures may be formed by a single part.

Instead of being over molded on the washer 44, the bushing 42 and/or the endplate 46 may be mounted clamped or crimped on the washer 44.

It is particularly advantageous if the bushing 42 and the endplate 46 are made in a same material. This allows manufacturing of a half-shaft by setting up the washer 44 in a mold and by overmolding the parts 42 and 46 in a single operation. However, alternatively, the parts 42 and 46 may be made with two distinct materials, which allow the use of specific mechanical properties for each of these parts in return for a molding in two steps.

The fact that both half-shafts 40A and 40B are identical is advantageous in terms of production. Alternatively, both of these shafts may not be identical. In particular, the lengths of the bushings 42 of both half-shafts may be different.

According to another alternative, a single hollow shaft is used, the bushing of which extends over the whole length of the inner ring of the bearing or over only one portion of this length. In the latter case, the hollow shaft only comprises a flange at one of its ends.

According to a further alternative of the invention, the hollow shaft may extend axially beyond a lateral edge of the remainder of the device 2, notably beyond a lateral edge of the pulley 30, so that this hollow shaft forms alone a positioning spacer relatively to a support such as the engine block 4. This is particularly advantageous when this engine block is not equipped with a boss such as the boss 6 illustrated in FIG. 4.

According to an alternative for manufacturing a half-shaft 40A or 40B, the bushing 42 and the endplate 46 are made separately from each other, notably in plastic material, and then attached on the washer 44 with a suitable method, notably by vulcanization or by adhesive bonding.

The invention is described above in the case of its application for an idler pulley. It is also applicable to a tensioning roller, to a winder and more generally to any pulley device type.

The embodiments and alternatives contemplated above may be combined together in order to generate novel embodiments of the invention.

1. A pulley device for one of a belt or a chain, the pulley device comprising:
a bearing provided with an external ring, an internal ring and at least a row of rolling elements mounted in a bearing chamber defined between the external and internal rings;
a pulley secured in rotation with the external ring and provided with an external radial surface for engaging with one of the belt or the chain; and
at least one hollow shaft able to receive a screw for mounting of the pulley device on a support;
wherein the hollow shaft forms a structural unit comprising a bushing and a flange secured to the bushing and which radially extends from the latter, outwards with respect to a central axis of the hollow shaft, as far as the bearing chamber,
wherein the flange is formed with a washer and an endplate and in that the washer is radially located between the bushing and the endplate.

2. The pulley device according to claim 1, wherein an external radial edge of the flange forms a joint which cooperates with at least one of the external ring and the pulley for isolating the bearing chamber from the outside of the device.

3. The pulley device according to claim 1, wherein the washer is produced in a material that is more rigid than the material of the endplate and positioned for receiving, with axial support, a head of a screw for mounting the device on at least one of a support and one of a raised or recessed portion of the support.

4. The pulley device according to claim 3, wherein the washer is metallic and the endplate is made in a synthetic material.

5. The pulley device according to claim 3, wherein the washer is metallic and the endplate is made in polyamide 6-6.

6. The pulley device according to claim 3, wherein the washer is metallic and the endplate is made in a material comprising reinforcement fibers.

7. The pulley device according to claim 1, wherein the washer is provided with at least one of raised and recessed portions cooperating with mating at least one of raised and recessed portions of at least one of the bushing and the endplate and participating in relative immobilization of these parts.

8. The pulley device according to claim 1, wherein the axial thickness of the washer is less than its radial thickness relatively to a central axis of the hollow shaft.

9. The device according to claim 8, wherein a ratio of the axial thickness of the washer over its axial width is between 0.1 and 0.5.

10. The device according to claim 8, wherein a ratio of the axial thickness of the washer over its axial width is equal to 0.3.

11. The pulley device according to claim 1, further comprising two identical hollow shafts, each identical hollow shaft forming a structural unit comprising a bushing and a flange, in that the bushings are each aligned along a central axis of the bearing and in that the flanges are each positioned on one side of the bearing chamber, along the central axis of the bearing.

12. A method for manufacturing a hollow shaft of a pulley device, the pulley device comprising:
a bearing provided with an external ring, an internal ring and at least a row of rolling elements mounted in a bearing chamber defined between the external and internal rings;
a pulley secured in rotation with the external ring and provided with an external radial surface for engaging with one of a belt or a chain; and
at least one hollow shaft able to receive a screw for mounting of the pulley device on a support;
wherein the hollow shaft forms a structural unit comprising a bushing and a flange secured to the bushing and which radially extends from the latter, outwards with respect to a central axis of the hollow shaft, as far as the bearing chamber,
wherein the flange is formed with a washer and an endplate and in that the washer is radially located between the bushing and the endplate,
the method comprising at least one step of overmolding at least one of the bushing and the endplate on the washer.

13. A method for assembling a pulley device for one of a belt or a chain, the pulley device comprising:
a bearing provided with an external ring, with an internal ring and the with at least a row of rolling elements mounted in a bearing chamber defined between the internal and external rings;
a pulley secured in rotation with the external ring and provided with an external radial surface for engaging with one of the belt or the chain; and
at least one hollow shaft capable of receiving a screw for mounting the pulley device on a support,
the method comprising preliminary steps for mounting the bearing and the pulley including a step subsequent to the preliminary steps and consisting in engaging into the inside of the internal ring of the bearing a bushing belonging to a structural unit forming a hollow shaft, by bringing opposite to the bearing chamber, along an axial direction, an endplate belonging to a flange secured to the bushing and belonging to the structural unit, and in that this endplate forms, with a washer radially located between the endplate and the bushing, the flange.

14. A method for assembling a pulley device for a belt or chain, the pulley device comprising:
a bearing provided with an external ring, with an internal ring and with at least one row of rolling elements mounted in a bearing chamber defining between the internal and external rings;
a pulley secured in rotation with the external ring and provided with an external radial surface for engaging with a belt or chain; and
at least one hollow shaft able to receive a screw for mounting the pulley device on a support,
the method comprising steps of:
overmolding in the inside of the internal ring of the bearing, a bushing belonging to a structural unit forming a hollow shaft; and
attaching an endplate on a washer in order to form a flange of the hollow shaft by one of overmolding, adhesive bonding, tightened mounting, crimping or vulcanization.
